(19) United States
(12) Patent Application Publication
(10) Pub. No.: US 2013/0110707 A1
(43) Pub. Date: May 2, 2013

(54) METHODS, SOFTWARE AND DEVICES FOR FACILITATING FUNDRAISING EVENTS OVER THE INTERNET

(71) Applicant: Brad Robins, King City (CA)

(72) Inventor: Brad Robins, King City (CA)

(21) Appl. No.: 13/282,058

(22) Filed: Oct. 26, 2011

(51) Int. Cl. G06Q 99/00; G06Q 40/00

(52) U.S. Cl. 705/39; 705/329

(57) ABSTRACT

Methods, software and devices for fundraising events over the Internet are disclosed. Donations are collected on behalf of a donee using collaborative puzzles to be solved by donors. For each fundraiser, a a collaborative puzzle is defined by defining regions in a fundraising image and associating with each region a requested donation amount. Donors are notified of the puzzle based on electronic contact information received from each fundraiser. A representation of the collaborative puzzle is presented donors. The representation includes a depiction of the fundraising image, in which some of the regions are obscured, and others are unobscured. The Obscured regions are those for which an associated requested donation amount has not yet been received, while unobscured regions are those for which an associated requested donation amount has been received. Donation amounts are received from donors and then provided to the donee.

### FIELD OF THE INVENTION

The present invention relates to networked computing devices, and more particularly to methods, software, and devices for facilitating fundraising events over the Internet.

### BACKGROUND OF THE INVENTION

Many charitable, religious and political organizations rely on donations to fund their operations. These donee organizations typically solicit donations by holding fundraising events.

In holding a fundraising event, donee organizations face a common problem: communicating their aims and needs effectively and efficiently to a large number of potential donors. Some organizations use television broadcasts to communicate their donation requests to donors. Others deploy a host of fundraisers to solicit donations door-to-door. These solutions are often costly and/or labour-intensive.

Upon reaching out to donors, donee organizations often face the additional problem of providing incentives to encourage donors to make a donation. As such, some organizations offer an item in exchange for a donation. The iconic Girl Scout cookie is an example of such an item, though other examples abound: chocolate bars, pins, baubles, etc. As donee organizations typically try to appeal to the charitable spirit of donors, the value of the items may be nominal.

In recent years, the proliferation of Internet users and services has made communication faster, easier and cheaper. Access to electronic communication services such as e-mail and instant messaging is nearly ubiquitous in many parts of the world.

Accordingly, there is a need for improved methods, software, and devices to facilitate fundraising over the Internet, leveraging electronic communication, social networking and payment services over the Internet.

### SUMMARY OF THE INVENTION

In accordance with the present invention, donations to fundraising events are collected on behalf of a donee using collaborative puzzles to be solved by donors. For each fundraiser, a fundraising image is received and a collaborative puzzle is defined by defining regions in the fundraising image and associating with each region a requested donation amount. Then, donors are notified of the collaborative puzzle based on electronic contact information received from each fundraiser. A representation of the collaborative puzzle is presented donors. The representation includes a depiction of the fundraising image, in which some of the regions are obscured, and other regions are unobscured. The obscured regions are those for which an associated requested donation amount has not yet been received, while the unobscured regions are those for which an associated requested donation amount has been received. Donation amounts corresponding at least one of the obscured regions are received from donors and then provided to the donee.

In accordance with an aspect of the present invention there is provided a computer-implemented method of collecting donations to fundraising events on behalf of a donee using collaborative puzzles to be solved by donors. The method comprises for each fundraising event: receiving electronic contact information for a plurality of fundraisers from the donee; and providing electronic notification of the fundraising event to each of the plurality of fundraisers. The method further comprises for each of the plurality of fundraisers: receiving an indicator of a fundraising image from the fundraiser; defining a collaborative puzzle by defining a plurality of regions in the fundraising image and associating with each of the plurality of regions a requested donation amount; receiving electronic contact information for a plurality of donors from the fundraiser; providing electronic notification of the collaborative puzzle to each of the plurality of donors; presenting a representation of the collaborative puzzle to at least one donor of the plurality of donors, the representation comprising a depiction of the fundraising image, in which at least some of the plurality of regions are obscured, and others of the plurality of regions are unobscured, wherein the regions that are obscured are regions for which an associated requested donation amount has not yet been received, and wherein regions that are unobscured are regions for which an associated requested donation amount has been received; receiving from the at least one donor a new donation amount corresponding to at least one of the plurality of regions that is obscured; and providing the new donation amount to the donee.

In accordance with another aspect of the present invention, there is provided a host computing device for collecting donations to fundraising events on behalf of a donee using collaborative puzzles to be solved by donors. The host computing device comprises: a processor, memory in communication with the processor, and software code stored in the memory executable on the processor. The software code adapts the host computing device to: for each fundraising event, receive electronic contact information for a plurality of fundraisers from a donee computing device operated by the donee; based on the received electronic contact information for the plurality of fundraisers, send electronic notification of the fundraising event to a plurality of fundraiser computing devices respectively operated by the plurality of fundraisers; receive an indicator of a fundraising image from at least one fundraiser computing device of the plurality of fundraiser computing devices; define a collaborative puzzle by defining a plurality of regions in the fundraising image and associating with each of the plurality of regions a requested donation amount; receive electronic contact information for a plurality of donors from the at least one fundraiser computing device; based on the received electronic contact information for the plurality of donors, send electronic notification of the collaborative puzzle to each of a plurality of donor computing devices respectively operated by the plurality of donors; send an electronic representation of the collaborative puzzle to at least one donor computing device of the plurality of donor computing devices, the electronic representation comprising a depiction of the fundraising image, in which at least some of the plurality of regions are obscured, and others of the plurality of regions are unobscured, wherein the regions that are obscured are regions for which an associated requested donation amount has not yet been received, and wherein regions that are unobscured are regions for which an associated requested donation amount has been received; and receive from the at least one donor computing device an indicator of a new donation amount corresponding to at least one of the plurality of regions that is obscured.

Other aspects and features of the present invention will become apparent to those of ordinary skill in the art upon review of the following description of specific embodiments of the invention in conjunction with the accompanying figures.

### BRIEF DESCRIPTION OF THE DRAWINGS

In the figures which illustrate by way of example only, embodiments of the present invention,

FIG. 1 is a network graph illustrating exemplary network connectivity of a donee, fundraisers, and donors;

FIG. 2 is a network diagram illustrating a computer network interconnecting a fundraising facilitator server, a social networking server and computing devices operated by donees, fundraisers, and donors, exemplary of one embodiment of the present invention;

FIG. 3 is a high level block diagram of a computing device for use as the fundraising facilitator server of FIG. 2;

FIG. 4 illustrates the software organization of the fundraising facilitator server of FIG. 2;

FIG. 5 illustrates the software organization of software at the fundraising facilitator server of FIG. 2;

FIGS. 6A and 6B illustrate exemplary shapes for regions of digital puzzle images to be created by the image generator application of FIG. 5;

FIG. 7 is a flow chart illustrating exemplary blocks performed by the facilitator applications of FIG. 4 to create a new event;

FIG. 8 is a flow chart illustrating exemplary blocks performed by the facilitator applications of FIG. 4 to create a new simulated puzzle;

FIG. 9 is a flow chart illustrating exemplary blocks performed by the facilitator applications of FIG. 4 to collect a donation;

FIG. 10 illustrates an exemplary screen provided by the event creator application of FIG. 5;

FIG. 11 illustrates an exemplary screen provided by the puzzle creator application of FIG. 5; and

FIGS. 12 and 13 illustrate exemplary screens provided by the donation collector application of FIG. 5.

### DETAILED DESCRIPTION

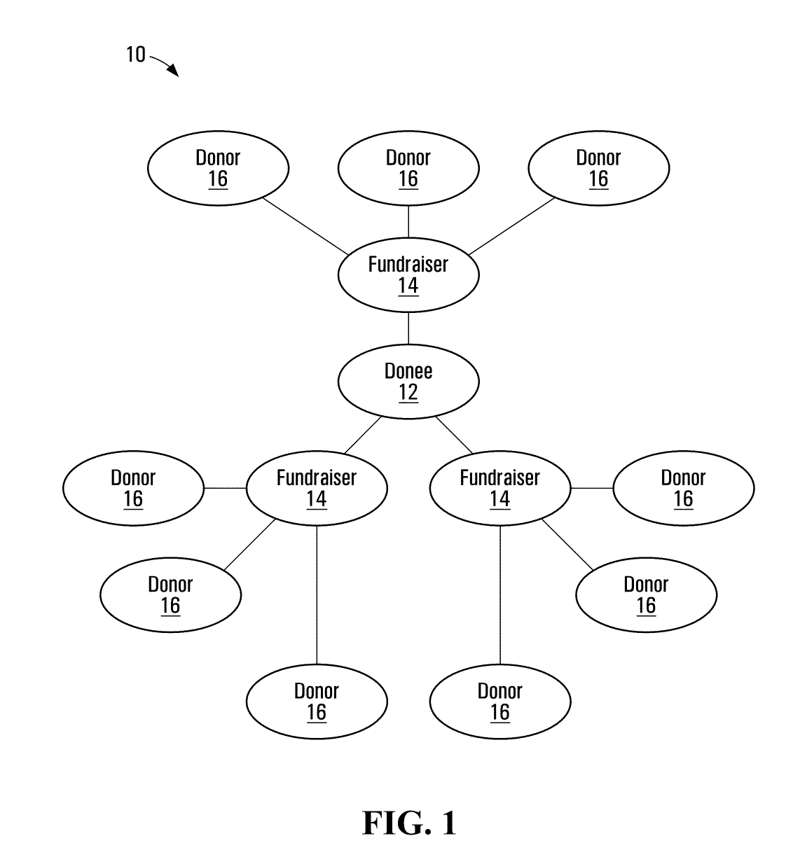

FIG. 1 is a network graph illustrating exemplary social connectivity of a donee 12, multiple fundraisers 14, and multiple donors 16 within a social network 10. Donee 12 is an entity soliciting donations from donors 16, and may be an individual or an organization, such as charitable, religious or political organization. Donors 16 may be actual donors, or prospective donors, that may donate to a fundraising cause or event for the benefit of donee 12.

In the graph, donee 12 is connected to multiple fundraisers 14. Fundraisers 14 are entities (typically individuals) who are willing or obliged to solicit donations on behalf of donee 12, for one or more fundraising events. Fundraisers 14 may, for example, be employees or volunteers working for donee 12.

As well, each fundraiser 14 is in turn connected to multiple donors 16 in the graph. Donors 16 may provide donations to donee 12 when solicited by a fundraiser 14. Each donee 12 is thus connected to a large number of donors 16 through social network 10. FIG. 1 illustrates social network connectivity for one donee 12 and one fundraising event. There may be multiple donees 12, with each donee 12 connected to its own fundraisers 14 and donors 16 through its own social network 10. As well, for any particular donee 12, the social network connectivity for each fundraising event may be unique, with different fundraisers and donors, interconnected for each event.

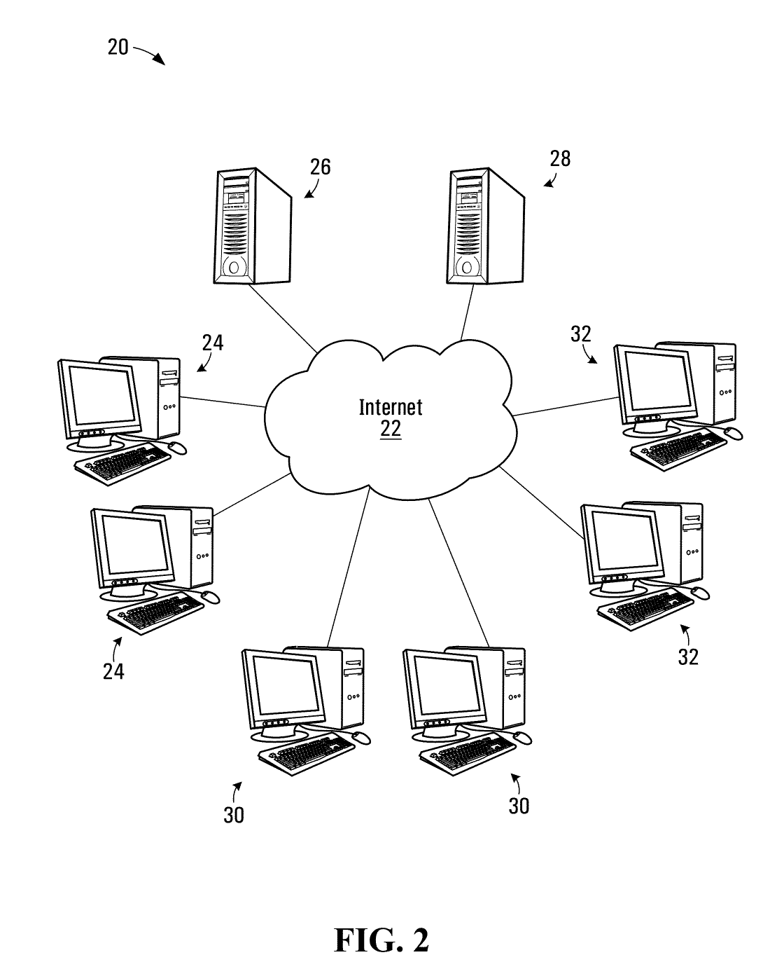

FIG. 2 is a network diagram illustrating a network arrangement of multiple computing devices interconnected by public Internet 22, corresponding to computing devices for donee 12, donors 16 and fundraisers 14 of FIG. 1. In particular, as illustrated, donee computing devices 24, each operated by a donee 12; fundraiser computing devices 30, each operated by a fundraiser 14; and donor computing devices 32, each operated by a donor 16 are interconnected with a fundraising facilitator server 26, which provides web and e-mail services to facilitate collection of donations from donors 16 by fundraisers 14 on behalf of donees 12 in manners of an embodiment of the present invention.

Donee computing devices 24, fundraiser computing devices 30 and donor computing devices 32 are also interconnected with a social networking server 28, which corresponds to a server operated a third-party online social networking service such as Facebook, Myspace, LinkedIn, and Google+. Social networking server 28 stores social networking data corresponding to a social network 10, and may provide an application programming interface (API) for retrieving stored social network data.

Donee computing devices 24, fundraiser computing devices 30, and donor computing devices 32 are entirely conventional network-aware computing devices, capable of executing a suitable web browser. Computing devices 24, 30, 32 may, for example, be a personal computer, a laptop computing device, a network computing device, a tablet computing device, a personal digital assistance, a cellular telephone, or the like.

Internet 22 may include wired and wireless points of access, including wireless access points, and bridges to other communications networks, such as GSM/GPRS/3G or similar wireless networks. Any of computing devices 24, 30, 32 may be connected to Internet 22 through one or more local area networks (LANs) (not shown).

As will become apparent, fundraising facilitator server 26 under software control allows donees, like donee 12 to engage fundraisers 14, who in turn solicit donations for the benefit of donee 12 from potential donors 16.

Electronic communication over Internet 22 allows for cheap and near-instantaneous communication between donees, fundraisers and donors, while online payment services may allow donors to make pay for donations electronically.

Conveniently, and as detailed below, donations may be solicited, by allowing potential donors 16 to collaboratively solve a virtual jigsaw puzzle, to expose an image chosen by fundraiser 14. More specifically, donors 16 are presented with pieces of an image/puzzle that may be uncovered in return for a donation. Collaboration by multiple donors 16 will expose the image, satisfy the collaborating donors 16, and raise funds for donee 12.

Funds may be transferred using electronic commerce over the Internet using electronic payment services such as credit card processing services and escrow services, e.g., Paypal or Google Wallet, to pay for goods and services.

Further, the advent of online social networking services such as Facebook, Myspace, LinkedIn, and Google+allows donors, donees, and fundraisers to more easily be identified and linked. Online social networks can connect donee organizations with their fundraisers, and in turn can connect each of those fundraisers with multiple donors. Thus, online social networks can connect donee organizations to a large number of donors through social networks. Advantageously, many connections in these social networks may pre-exist a fundraising event; for example, fundraisers are likely already connected to family, friends and colleagues, many of whom may be donors.

To these ends, fundraising facilitator server 26 provides web pages to each donee 12, fundraiser 14 and donor 16 to facilitate collection of donations from donors 16 by fundraisers 14 on behalf of donees 12, in manners exemplary of embodiments of the present invention. Server 26 provides web pages to donees 12 to create a new fundraising event and provides notification of the fundraising event by e-mail or other electronic messaging media to fundraisers 14. Server 26 further provides web pages to fundraisers 14 to allow fundraisers 14 to create simulated items to solicit donations from donors 16, the simulated items formed as puzzle pieces of a simulated or virtual puzzle, and provides notification of the fundraising event by e-mail or other electronic messaging media to donors 16 connected to each fundraiser 14. Server 26 further provides web pages to donors 16 to view digital puzzle images visually representative of simulated puzzles, and to make donations to donees 12.

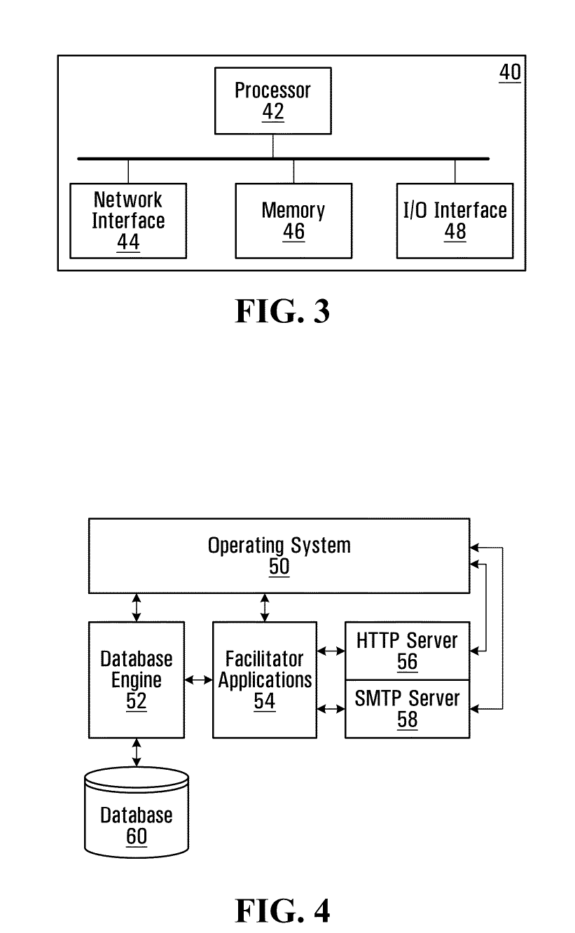

FIG. 3 is a simplified block diagram of a computing device 40 that may act as fundraising facilitator server 26. In particular, as illustrated, computing device 40 includes processor 42, network interface 44, a suitable combination of persistent storage memory 46, random access memory and read only memory. Network interface 44 interconnects computing device 40 to a network such as Internet 22. Additional input/output peripherals such as keyboard, monitor, mouse, and the like of device 40 are not specifically detailed herein. These may be interconnected to device 40 by one or more I/O interfaces 48. Device 40 may for example be a conventional x86 based, Windows NT, Windows Vista, Windows XP, Windows 7, Apple, Macintosh, Linux, Solaris or similar based network server, known to those of ordinary skill. As will become apparent, device 40 acting as fundraising facilitator server 26 may further host software allowing it to function in manners exemplary of embodiments of the present invention.

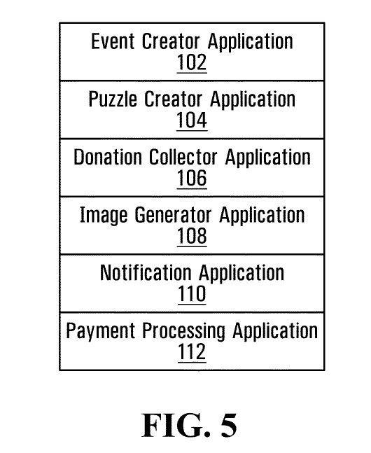

FIG. 4 illustrates a simplified organization of example software components stored within persistent memory (i.e., persistent storage memory 46) of fundraising facilitator server 26 as depicted in FIG. 3. As will be appreciated, software components embodying depicted functional blocks may be loaded from a computer readable medium and stored within persistent storage memory 46 at fundraising facilitator server 26. As illustrated, software components preferably include operating system (OS) software 50, a database engine 52, a database 60, facilitator applications 54, an HTTP web server application 56, and an SMTP e-mail server application 58, exemplary of embodiments of the present invention.

As noted, OS software 50 may, for example, be a Unix-based operating system (e.g., Linux, FreeBSD, Solaris), a Microsoft Windows operating system, or the like. OS system software 50 may also include a TCP/ICP stack allowing communication of fundraising facilitator server 26 with Internet 22 using the TCP/IP protocol. Database engine 52 may be a conventional relational or object oriented database engine, such as Microsoft SQL Server, Oracle, DB2, Sybase, Pervasive or any other database engine known to those of ordinary skill in the art. Database engine 52 provides access to one or more databases 60, and thus typically includes an interface for interaction with operating system software 50, and other software, such as facilitator applications 54. Database 60 may be a relational or object oriented database. As will become apparent, database 60 stores data associated with event fundraising event and each simulated puzzle. HTTP server application 56 is a conventional HTTP web server application such as the Apache HTTP Server, nginx, Microsoft IIS or similar server application. HTTP server application 56 allows server 26 to act as a conventional HTTP server and provides a plurality of web pages, stored for example as (X)HTML or similar code, for access by network-interconnected computing devices such as computing devices 24, 30 and 32. Web pages may be implemented using traditional web languages such as HTML, XHTML, Java, Javascript, Ruby, Python, Perl, PHP, Flash or the like. SMTP server application 58 is a conventional SMTP e-mail server such as Microsoft Exchange, Postfix, Sendmail or similar server application. SMTP server application 56 allows server 26 to act as a conventional SMTP server for sending e-mails generated by facilitator applications 54 to be received by computing devices 24, 30 and 32.

Facilitator applications 54 adapt server 26, in combination with database engine 52, database 60, OS software 50, HTTP server application 56 and SMTP server application 58 to function in manners exemplary of embodiments of the present invention. Facilitator applications 54 may be written using conventional computing language such as C, C++, C#, Perl, Java, Visual Basic or the like. Facilitator applications 54 may include user interfaces written in a language allowing their presentation on a web browser, or code that will dynamically generate such user interfaces. User interfaces of facilitator applications 54 may solicit input from users of computing devices 24, 30 and 32, or provide output to users of computing devices 24, 30 and 32. User interfaces of facilitator applications 54 may be provided in HTML, XHTML, Java, Flash or the like to HTTP server application 56 for access by network-interconnected computing devices 24, 30 and 32.

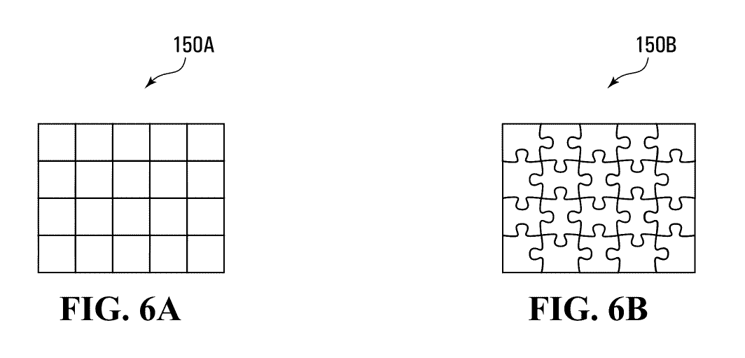

In the embodiment schematically illustrated in FIG. 5, facilitator applications 54 include event creator application 102, puzzle creator application 104, donation collector application 106, image generator application 108, notification application 110 and payment processing application 112.

Event creator application 102 is used by each donee 12 operating a donee computing device 24 to create a new fundraising event. Event creator application 102 includes a user interface in the form of one or more web pages, provided to the donee computing device 24 by HTTP server application 56.

Through this user interface, event creator application 102 receives from the donee 12 event information describing a new fundraising event. Event creator application 102 also receives account information from a donee 12 for a third-party social networking service provided at social networking server 28. Using this account information and if available, an API for the social networking service, event creator application 102 retrieves a list of individuals in the social network of the donee 12 from social networking server 28. Event creator application 102 presents this list to the donee 12 and prompts the donee 12 to select one or more fundraisers 14 from the list. Event creator application 102 then retrieves electronic contact information for each fundraiser 14, as selected, from social networking server 28. Alternatively, event creator application 102 may receive electronic contact information for fundraisers 14 directly from donee 12, without receiving account information for a social networking service or communicating with social networking server 28. Event creator application 102 also receives from donee 12 electronic contact information for donee 12 and electronic payment information for donee 12.

Event creator application 102 stores the received event information, electronic contact information for fundraisers 14, electronic contact information for the donee 12, and electronic payment information for the donee 12, along with an event ID uniquely identifying the event in database 60 using database engine 52. Event creator application 102 makes a request to notification application 110 to notify fundraisers 14 of the new event, and further to provide fundraisers 14 with a Uniform Resource Locators (URL) to access puzzle creator application 104.

Puzzle creator application 104 is used by each fundraiser 14 operating a fundraiser computing device 30 to create a simulated puzzle. The simulated puzzle may be a simulated/virtual puzzle, with each puzzle piece resembling a jigsaw puzzle piece. Each simulated puzzle has a number of puzzle pieces (piece0, piece1, piece2 . . . ) and is simulated visually in the form of a digital puzzle image having a number of regions (region0, region1, region2 . . . ). Each region of the digital puzzle image simulates a corresponding puzzle piece of the simulated puzzle. As detailed below, before any donations have been received for any puzzle piece of a simulated puzzle, the digital puzzle image shows an obscured visual representation of the simulated puzzle. When a donation is received for a puzzle piece, the digital puzzle image visually simulating the digital puzzle changes to reveal the region corresponding to that puzzle piece.

Puzzle creator application 104 identifies the particular fundraising event for which the fundraiser 14 is soliciting donations based on the URL used by fundraiser 14 to access the puzzle creator application or an event ID received from fundraiser 14, corresponding to an event ID stored in database 60. Puzzle creator application 104 includes a user interface in the form of one or more web pages, provided to the fundraiser computing device 30 by HTTP server application 56.

Through this user interface, puzzle creator application 104 receives from fundraiser 14 one or more digital source images for forming a digital puzzle image. The digital source images may be encoded as a GIF, TIFF, JPEG, JPEG 2000, PNG file, or the like. Digital source images received by puzzle creator application 104 from fundraiser 14 are stored at server 26. As an alternative to receiving one or more digital source images, puzzle creator application 104 may instead receive URLs corresponding the digital source images stored at a remote server, or a URL for a photo album containing digital source images, for example stored at social networking server 28. When puzzle creator application 104 receives URLs for remotely-stored digital source images, puzzle creator application 104 may either retrieve copies of the digital source images using the URLs and store the retrieved digital source images at server 26, or simply store the received URLs at server 26.

Puzzle creator application 104 may receive from fundraiser 14 account information for a third-party social networking service provided at social networking server 28. Using this account information and if available, an API for the social networking service, puzzle creator application 104 retrieves a list of individuals in the social network of fundraiser 14 from social network server 28. Puzzle creator application 104 presents this list to fundraiser 14 and prompts fundraiser 14 to select one or more donors 16 from the presented list of contacts. Puzzle creator application 102 then retrieves electronic contact information for each donor 16, as selected, from social networking server 28. Alternatively, puzzle creator application 104 may receive electronic contact information for donors 16 from fundraiser 14 directly without receiving account information for a social networking service or communicating with social networking server 28.

Puzzle creator application 104 creates a simulated/virtual puzzle. The puzzle may have a number of puzzle pieces as a data structure containing a number of data elements, wherein each data element corresponds to one puzzle piece (piece0, piece1, piece2 . . . ). The number of puzzle pieces, and hence the number of data elements, may be pre-defined or received from each fundraiser 14. Each data element stores a region indicator of a region in a digital puzzle image visually simulating the puzzle piece (e.g., region0, region1, region2 . . . ); the requested donation amount to be solicited from donors 16 for the puzzle piece; and a state indicator of whether or not a donation has been received for the puzzle piece. The requested donation amounts for the puzzle pieces may be pre-determined, received from fundraiser 14, or automatically generated within a range received from fundraiser 14.

Puzzle creator application 104 stores the data structure for the simulated puzzle and electronic contact information for donors 16, along with a puzzle ID uniquely identifying the simulated puzzle, in database 60 using database engine 52. Puzzle creator application 104 makes a request to notification application 110 to notify donors 16 of the new simulated puzzle for the new fundraising event, and further provides donor 16 with a URL to access donation collector application 106. Donors 16 are thus invited to participate in the fundraising event.

Donation collector application 106 is used by each donor 16 operating a donor computing device 32 to make a donation to a donee 12. The particular simulated puzzle to be presented the donor may be identified based on the URL used by the donor 16 to access the donation collector application or a puzzle ID received from the donor 16, corresponding to a puzzle ID stored in database 60. Donation collector application 106 includes a user interface in the form of one or more web pages, provided to each donor computing device 30 by HTTP server application 56.

Donation collector application 106 communicates with image generator application 108 to generate a digital puzzle image visually simulating the simulated puzzle. Each region of the digital puzzle image corresponds to puzzle pieces for which a donation has not yet been received is obscured while each region of the digital puzzle image corresponding to puzzle pieces for which a donation has already been received is unobscured. Donation collector application 106 retrieves the requested donation amounts associated with puzzle pieces for which donations have not yet been received from database 60 using database engine 52. Donation collector application 106 presents the digital puzzle image and requested donation amounts, as retrieved from database 60, to the donor 16 using the provided user interface.

This user interface allows a donor 16 to select one or more obscured regions of the digital puzzle image. Donation collector application 106 receives from a donor 16 a selection of one or more obscured regions of the digital puzzle image from donor 16, indicating that the donor is making a donation for the puzzle pieces represented by the selected obscured regions.

Donation collector application 106 also receives from the donor 16 payment information, including a payment amount and credit card billing information or account information for a third-party payment escrow services such as Paypal or Google Wallet. The payment amount corresponds to the sum of the requested donation amounts associated with the selected obscured regions. Donation collector application 106 provides this payment information to payment processing application 112, which collects the payment from the donor 16 and transfers the payment to the donee 12 to whom the donation was made.

After a donation is collected, donation collector application 106 again communicates with the image generator application 108 to generate an updated digital puzzle image, in which the regions of the updated digital puzzle image corresponding to puzzle pieces for which a donation has now been received from the donor 16 are now unobscured. Donation collector application 106 presents this updated puzzle image on a web page to the donor 16. Donation collector application 106 makes a request to notification application 110 to notify the fundraiser 14 and other donors 16 of the updated digital puzzle image.

Donation collector application updates the state indicators in the data structure for the simulated puzzle stored in database 60 using database engine 52 to indicate that donations have now been received for the particular puzzle pieces for which a donation has been received from donor 16. Thus, previously obscured regions of the puzzle now revealed to the donor 16 remain unobscured for all others who view the digital puzzle image thereafter. In this way, donors 16 who make donations for puzzle pieces of the same simulated puzzle can work in concert to reveal the entire digital puzzle image. The entire digital puzzle image becomes revealed, i.e., the simulated puzzle is solved, when a donation has been received for every puzzle piece.

Image generator application 108 generates a digital puzzle image visually simulating a simulated puzzle upon request from donation collector application 106. Image generator application 108 generates a digital puzzle image using known image manipulation methods. The digital puzzle image may be encoded as a GIF, TIFF, JPEG, JPEG 2000, PNG file, or the like.

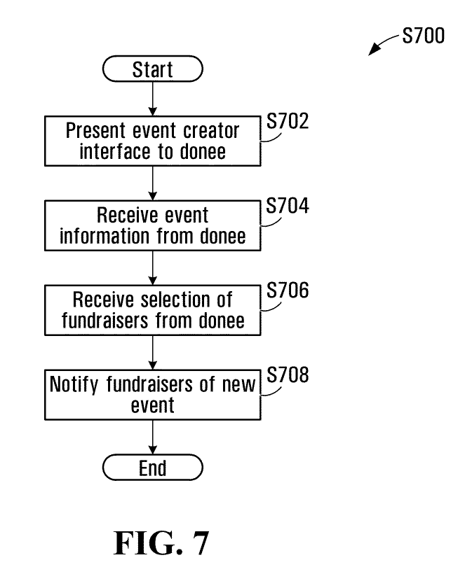

The digital puzzle image is formed by image generator application 108 to have multiple regions. The number of regions corresponds to the number of puzzle pieces in the simulated puzzle. As described above, this number also corresponds to the number of donations solicited by the fundraiser 14 who created the simulated puzzle. The regions of the digital puzzle image may be shaped according to templates 150A and 150B illustrated in FIGS. 6A and 6B, respectively. Although templates 150A and 150B each show twenty regions, the number of regions may vary depending on the desired number of puzzle pieces. In the depicted embodiment, the puzzle pieces have the appearance of a jigsaw puzzle pieces, and the collection of puzzle pieces may form a two-dimensional jigsaw puzzle. The shapes shown in templates 150A and 150B are exemplary only, and other suitable shapes will be readily apparent to a skilled person.

As detailed previously, regions of the digital puzzle image corresponding to puzzle pieces for which a donation has not yet been received are obscured, while the remaining regions are unobscured. Image generator application 108 identifies those puzzle pieces for which a donation has not yet been received by retrieving from database 60 using database engine 52 the state indicators in the data structure for the simulated puzzle.

When a digital source image previously provided to puzzle creator application 104 by the fundraiser 14 is stored on server 26, unobscured regions of the digital puzzle image are formed from pixels in a corresponding region of a digital source image. When a previously-provided digital source image is stored on a remote server, however, unobscured regions of the digital puzzle image are formed using transparent pixels, for example, by manipulating the alpha channel of the digital puzzle image. In this latter case, the digital puzzle image and remotely-stored digital source image are thereafter presented on a web page such that the digital puzzle image is overlaid on top of the digital source image.

Obscured regions of the digital puzzle image may be formed in a variety of ways. For example, an obscured region may be formed by filling the region entirely with pixels of a uniform colour, or an obscured image region may formed from pixels in a corresponding region of the digital source image after a blur function has been applied to that corresponding region. When the digital puzzle image is to be overlaid on top of a digital source image when presented on a web page, unobscured regions may be filled with opaque or semi-transparent pixels to fully or partially cover the pixels of the digital source image underneath. These ways of obscuring regions of the digital puzzle image are exemplary only, and a skilled person will readily appreciate other suitable ways of obscuring regions of the digital puzzle image.

Notification application 110 communicates with event creator application 102, puzzle creator application 104, donation collector application 106, and SMTP server application 58. Upon request by event creator application 102, puzzle creator application 104, or donation collector application 106, notification application 110 sends an e-mail using SMTP server application 58 to notify one or more of donee 12, fundraisers 14, or donors 16 in the manner requested, e.g., to notify a fundraiser 14 that a new fundraising event has been created, or to notify a donor 16 that a new simulated puzzle has been created. Notification application retrieves contact information for notification recipients, as needed, from database 60 using database engine 52. In some embodiments, notification application 110 does not send e-mail notifications using SMTP server application 58, but rather uses an alternate communication medium such MSN Web Messenger, AOL Instant Messenger, Google Talk, ICQ, Facebook Messaging SMS, or the like. In other embodiments, notification application 110 may send notifications using a combination of communication media.

Payment processing application 112 communicates with donation collector application 106 and with remote network-interconnected credit card processing services and/or payment escrow services. Upon receiving payment information for a donation by a donor 16 from donation collector application 106, payment processing application 112 sends this payment information to the appropriate credit card processing service or payment escrow services to collect electronic payment from donor 16. Upon receiving the payment, donation collector application 106 sends the payment electronically to the donee 12 to whom the donation was made, based on electronic payment information stored in database 60.

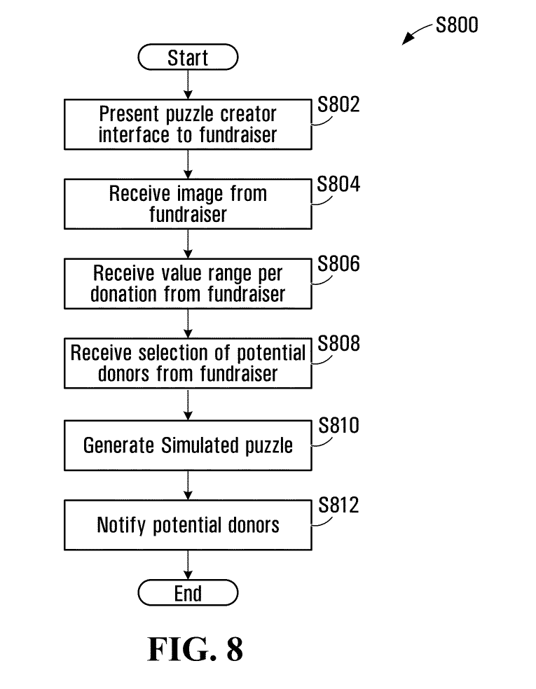

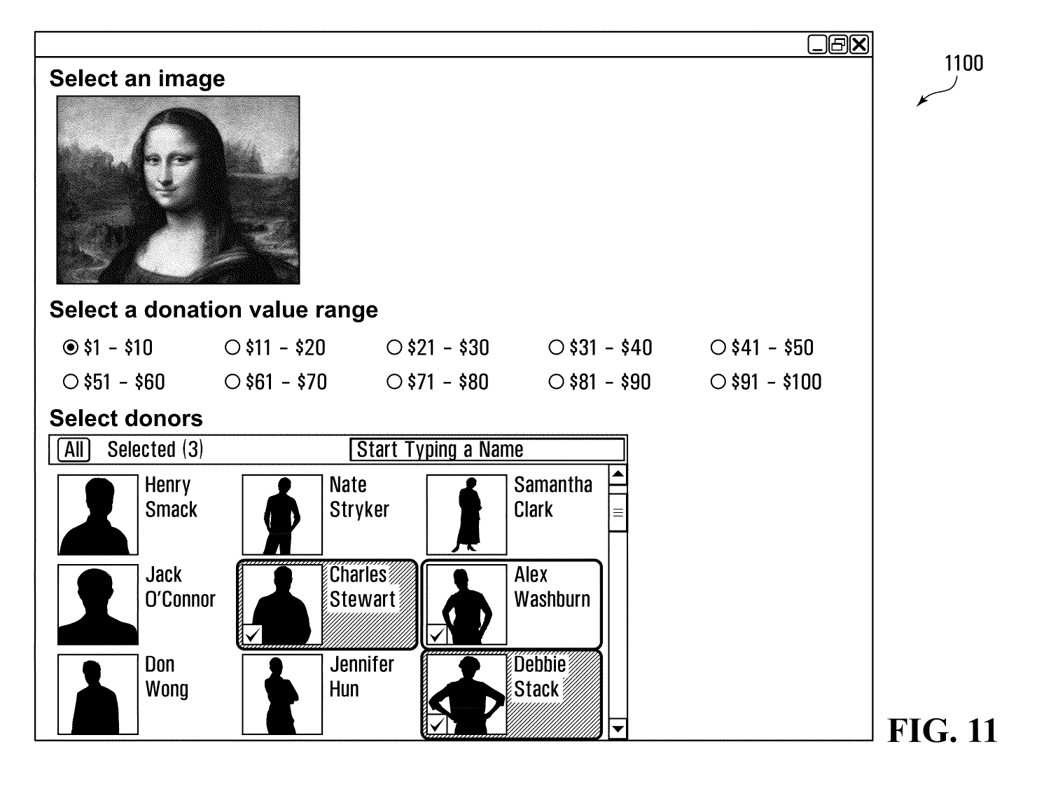

In operation, a donee 12 creates a new fundraising event by operating a web browser executing on a donee computing device 24 to contact fundraising facilitator server 26. In response, blocks S700 and onward illustrated in FIG. 7 are performed at server 26. In block S702, server 26 invokes event creator application 102 executing at server 26 to present web pages containing a user interface to the donee 12 using HTTP server application 56. Through this user interface, event creator application 102 solicits account information for a third-party social networking service provided at social networking server 28 from donee 12. Based on this account information, event creator application 102 retrieves a list of individuals in the social network of the donee 12 from social networking server 28. Event creator application 102 then presents this list of individuals to the donee 12 through the user interface, and solicits from the donee 12 event information describing the new fundraising event, and a selection of one or more fundraisers 14 from the presented list. The donee 12 may respond through the user interface as depicted in sample screen 1000 of FIG. 10. In sample screen 1000, the donee 12 has entered the text “Art Gallery of Ontario 2011 Fundraiser” to describe the fundraising event, and has selected three fundraisers 14: Samantha Clark, Tom Smith, and Julia Winters. The solicited event information and selection of fundraisers 14 are received by event creator application 102 at blocks S704 and S706, respectively. At block S708, event creator application 102 retrieves electronic contact information for each selected fundraiser 14 from social networking server 28. Alternatively, at block S708, if account information for a social networking service has not been provided by the donee 12, event creator application 102 may receive contact information for each fundraiser 14 directly from donee 12. Event creator application 102 then invokes notification application 110, which notifies each fundraiser 14 of the new fundraising event. After blocks S700 have been performed, event creator application 102 solicits and receives from the donee 12 electronic contact information and electric payment information for the donee 12.

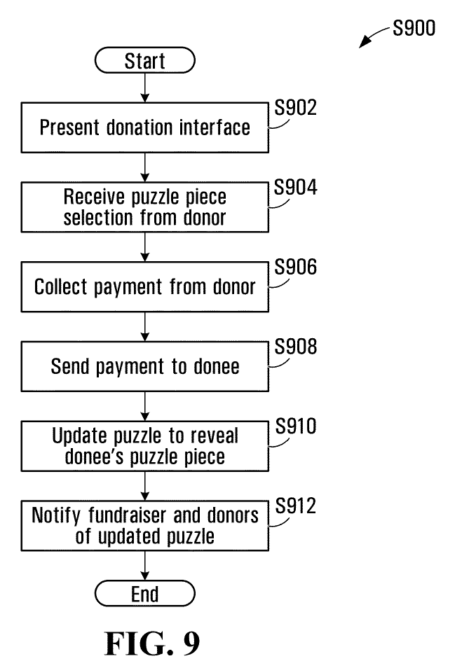

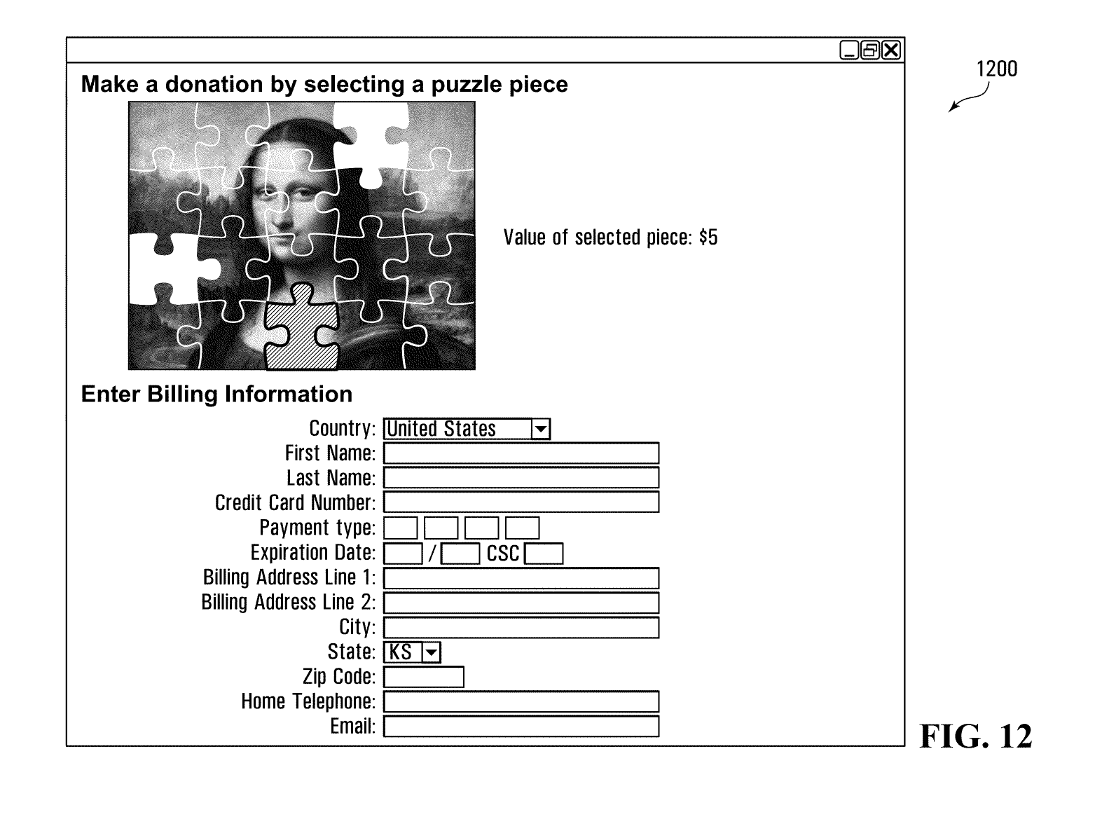

Next, a fundraiser 14, upon receiving notification of a new fundraising event, creates a new simulated puzzle by operating a web browser executing on a fundraiser computing device 30 to contact fundraising facilitator server 26. In response, blocks S800 and onward, illustrated in FIG. 8 are performed at server 26. In block S802, server 26 invokes puzzle creator application 104 executing at server 26 to present web pages containing a user interface to the fundraiser 14 using HTTP server application 56. Through this user interface, puzzle creator application 104 solicits account information for a third-party social networking service provided at social networking server 28 from the fundraiser 14. Based on this account information, puzzle creator application 104 retrieves a list of individuals in the social network of the fundraiser 14 from social networking server 28. Puzzle creator application 104 then presents this list of individuals to the fundraiser 14 through the user interface, and solicits from the fundraiser 14 one or more digital source images or one or more URLs for remotely-stored digital source images, the requested donation amount for the puzzle pieces of the new simulated puzzle, and a selection of one or more donors 16 from the presented list. The fundraiser 14 may respond through the user interface as depicted in sample screen 1100 of FIG. 11. In sample screen 1100, the fundraiser 14 has selected a digital source image as shown, a requested donation amount for each puzzle piece in the range of $1 to $10, and three donors 16: Charles Stewart, Alex Washburn, and Debbie Stack. The solicited digital source image, the requested donation amount range, and the selection of donors 16 are received by puzzle creator application 104 at blocks S804, S806 and S808, respectively. Puzzle creator application 104 may also solicit and receive from the fundraiser 14 the number of puzzle pieces desired. At block S810, puzzle creator application 104 creates the simulated puzzle based on the data structure detailed above. At block S812, puzzle creator application 104 retrieves electronic contact information for each selected donor 16 from social networking server 28. Alternatively, at block S812, if account information for a social networking service has not been provided by the fundraiser 14, puzzle creator application 104 may receive contact information for each donor 16 directly from fundraiser 14. Puzzle creator application 104 then invokes notification application 110, which notifies each donor 16 of the new simulated puzzle for the new fundraising event.

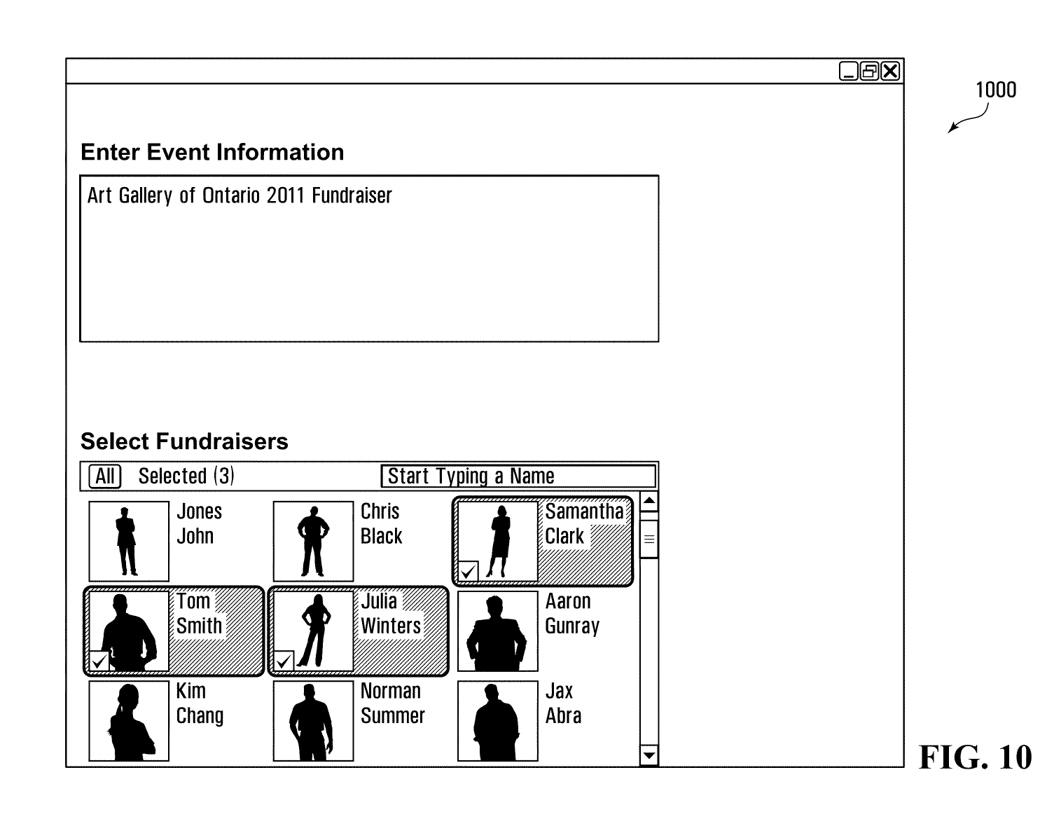

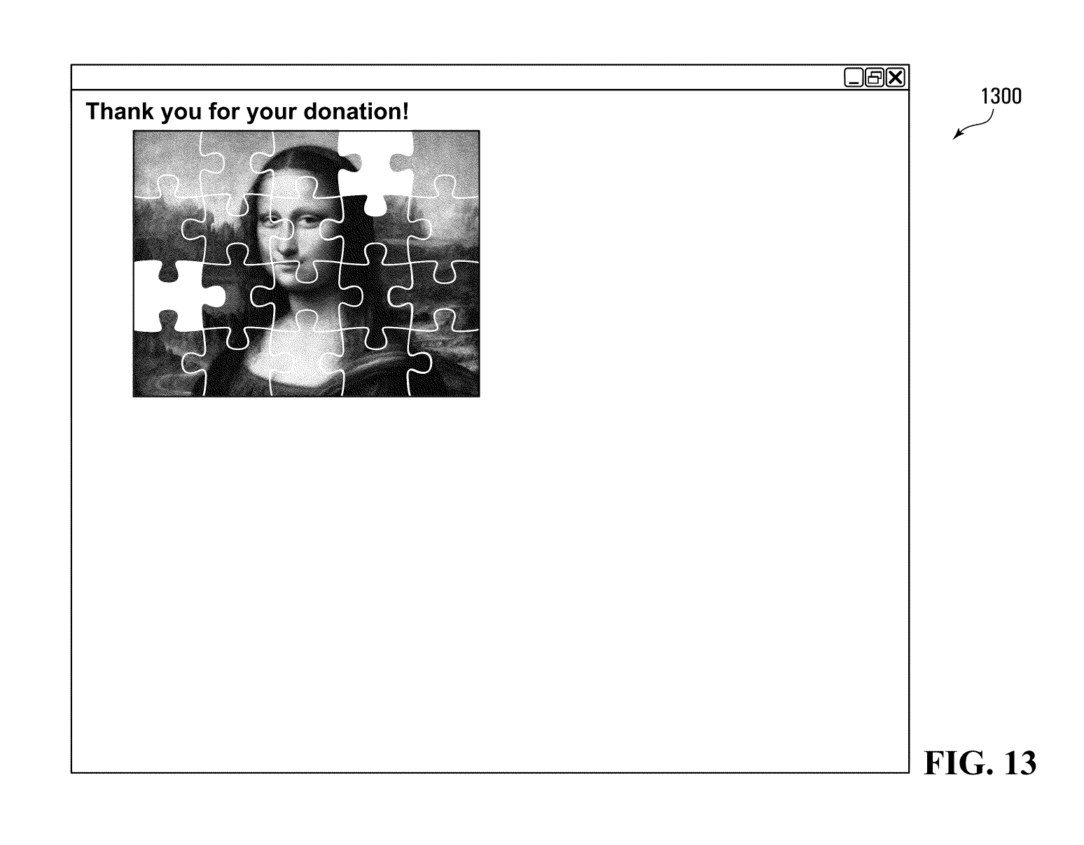

Next, a donor 16, upon receiving notification of a new fundraising event, makes a donation by operating a web browser executing on a donor computing device 32 to contact fundraising facilitator server 26. In response, blocks S900 and onward, illustrated in FIG. 9 are performed at server 26. In block S902, server 26 invokes donation collector application 106 executing on server 26 to present web pages containing a user interface to the donor 16 using HTTP server application 56. Donation collector application 106 in turn invokes image generator application 108 to generate a digital puzzle image, which is presented to the donor 16 using the user interface along with the requested donation amounts associated with puzzle pieces for which donations have not yet been received. As detailed above, each region of the digital puzzle image corresponding to puzzle pieces for which a donation has not yet been received is obscured, while each region of the digital puzzle image corresponding to puzzle pieces for which a donation has already been received is unobscured. At block S904, donation collector application 106 receives from the donor 16 a selection of one or more obscured regions of the puzzle image, indicating that the donor 16 is making a donation for the puzzle pieces represented by the selected obscured regions. Upon receiving this selection, at block S906, donation collector application 106 solicits payment information from the donor 16, as depicted in sample screen 1200 of FIG. 12.

As illustrated, donor 16 has selected one obscured region (indicated with hatched lines) and the requested donation amount for this piece is $5. Two other obscured regions are also present, but are not selected (indicated in white). The remaining regions are those for which donation amounts have already been received and are thus unobscured. Upon receiving payment information from the donor 16, donation collector application 106 invokes payment processing application 112 which uses the received payment information to collect payment from donor 16. Upon collecting payment from donor 16 at block S906, payment processing application 112 sends the payment to the particular donee 12 to whom the donation was made at block S908. At block S910, donation collector application 106 invokes image generator application 108 once again to generate an updated digital puzzle image. In this updated digital puzzle image, those regions corresponding to puzzle pieces for which a donation has now been received from the donor 16 are now unobscured, as depicted in sample screen 1300 of FIG. 13. As illustrated, the previously selected obscured region (previously indicated with hatched lines) is now unobscured and revealed to the donor 16. At block S912, donation collector application 106 invokes notification application 110, which notifies the fundraiser 14 and other donors 16 of the updated digital puzzle image. Blocks S900 may be repeated for each donor 16 making a donation until a donation has been received for all puzzle pieces.

Of course, the above described embodiments are intended to be illustrative only and in no way limiting. The described embodiments of carrying out the invention are susceptible to many modifications of form, arrangement of parts, details and order of operation. For example, software (or components thereof) described at a single computing device/server may be hosted at several devices. Likewise, software hosted at separate devices/servers, could be hosted at the same device. The invention, rather, is intended to encompass all such modification within its scope, as defined by the claims.

What is claimed is:

1. A computer-implemented method of collecting donations to fundraising events on behalf of a donee using collaborative puzzles to be solved by donors, said method comprising:
for each fundraising event:
receiving electronic contact information for a plurality of fundraisers from said donee; and
providing electronic notification of said fundraising event to each of said plurality of fundraisers;
for each of said plurality of fundraisers:
receiving an indicator of a fundraising image from said fundraiser;
defining a collaborative puzzle by defining a plurality of regions in said fundraising image and associating with each of said plurality of regions a requested donation amount;
receiving electronic contact information for a plurality of donors from said fundraiser;
providing electronic notification of said collaborative puzzle to each of said plurality of donors;
presenting a representation of said collaborative puzzle to at least one donor of said plurality of donors, said representation comprising a depiction of said fundraising image, in which at least some of said plurality of regions are obscured, and others of said plurality of regions are unobscured, wherein said regions that are obscured are regions for which an associated requested donation amount has not yet been received, and wherein regions that are unobscured are regions for which an associated requested donation amount has been received;
receiving from said at least one donor a new donation amount corresponding to at least one of said plurality of regions that is obscured; and
providing said new donation amount to said donee.

2. The method of claim 1, wherein said fundraising image is stored on a social networking server.

3. The method of claim 1, further comprising receiving said fundraising image.

4. The method of claim 1, wherein said electronic contact information for a plurality of donors from said fundraiser is received by way of a social networking server.

5. The method of claim 1, further comprising receiving an indicator of a desired number of regions, and wherein said defining a plurality of regions in said fundraising image is based on said indicator.

6. The method of claim 1, further comprising receiving an indicator of desired donation amounts for said plurality of regions and selecting each of said requested donation amounts based on said indicator.

7. The method of claim 1, wherein said providing electronic notification of said collaborative puzzle to each of said plurality of donors comprises sending an e-mail message to each of said plurality of donors.

8. The method of claim 1, further comprising upon receiving from said at least one donor said new donation amount, presenting an updated representation of said collaborative puzzle to said at least one donor, wherein said at least one region of said fundraising image corresponding to said new donation amount is unobscured.

9. The method of claim 1, wherein said new donation amount is received from said at least one as electronic payment.

10. The method of claim 1, further comprising maintaining state information that reflects those regions of said fundraising image for which said requested donation amount has not yet been received.

11. The method of claim 10, further comprising updating said state information each time a new donation amount has been received.

12. The method of claim 11, further comprising providing electronic notification to each of said plurality of donors of a change in said state information, after a new donation amount has been received.

13. The method of claim 1, wherein each region of said plurality of regions in said fundraising image resembles a jigsaw puzzle piece.

14. The method of claim 1, wherein said regions that are obscured are presented entirely with pixels of a uniform colour.

15. The method of claim 1, wherein said regions that are obscured are presented as blurred portions of said fundraising image.

16. A host computing device for collecting donations to fundraising events on behalf of a donee using collaborative puzzles to be solved by donors, wherein said host computing device comprises:
a processor;
memory in communication with said processor; and
software code stored in said memory executable on said processor that adapts said host computing device to:
for each fundraising event, receive electronic contact information for a plurality of fundraisers from a donee computing device operated by said donee;
based on said received electronic contact information for said plurality of fundraisers, send electronic notification of said fundraising event to a plurality of fundraiser computing devices respectively operated by said plurality of fundraisers receive an indicator of a fundraising image from at least one fundraiser computing device of said plurality of fundraiser computing devices;
define a collaborative puzzle by defining a plurality of regions in said fundraising image and associating with each of said plurality of regions a requested donation amount;
receive electronic contact information for a plurality of donors from said at least one fundraiser computing device;
based on said received electronic contact information for said plurality of donors, send electronic notification of said collaborative puzzle to each of a plurality of donor computing devices respectively operated by said plurality of donors;
send an electronic representation of said collaborative puzzle to at least one donor computing device of said plurality of donor computing devices, said electronic representation comprising a depiction of said fundraising image, in which at least some of said plurality of regions are obscured, and others of said plurality of regions are unobscured, wherein said regions that are obscured are regions for which an associated requested donation amount has not yet been received, and wherein regions that are unobscured are regions for which an associated requested donation amount has been received; and
receive from said at least one donor computing device an indicator of a new donation amount corresponding to at least one of said plurality of regions that is obscured.

17. The device of claim 16, wherein said software code stored in said memory executable on said processor further adapts said device to maintain state information that reflects those regions of said fundraising image for which said requested donation amount has not yet been received.

18. The device of claim 17, wherein said software code stored in said memory executable on said processor further adapts said device to update said state information each time an indicator of a new donation amount has been received.

19. The device of claim 18, wherein said software code stored in said memory executable on said processor further adapts said device to provide electronic notification to each of said plurality of donors of a change in said state information, after an indicator of a new donation amount has been received.

20. The device of claim 16, wherein each region of said plurality of regions in said fundraising image resembles a jigsaw puzzle piece.
